(19) United States
(12) Patent Application Publication
(10) Pub. No.: US 2014/0241776 A1
(43) Pub. Date: Aug. 28, 2014

(54) MEDIUM CARRYING DEVICE AND IMAGE FORMING APPARATUS

(71) Applicant: Oki Data Corporation, Tokyo (JP)

(72) Inventor: Haruo SATO, Tokyo (JP)

(73) Assignee: Oki Data Corporation, Tokyo (JP)

(21) Appl. No.: 14/190,521

(22) Filed: Feb. 26, 2014

(30) Foreign Application Priority Data
Feb. 27, 2013 (JP) 2013-036675

(51) Int. Cl. B65H 5/06; G03G 15/00

(52) U.S. Cl. CPC B65H 5/068; G03G 15/6529
USPC 399/388; 271/272

(57) ABSTRACT

A medium carrying device includes a first carrying part and a second carrying part that are configured to carry a medium, making a nip part therebetween. The guide member includes a medium regulation part having a surface to regulate the medium, an arm part that is at a side of the surface and extend in a direction away from the surface, and a rotation supporting point that is on a distal end of the arm part, and the guide member is formed rotatable around the rotation supporting point between the guide position and a retreat position, the retreat position being more distant to the nip part than the guide position.

### CROSS REFERENCE TO RELATED APPLICATION

The present application is related to, claims priority from and incorporates by reference Japanese Patent Application No. 2013-036675, filed on Feb. 27, 2013.

### TECHNICAL FIELD

The present invention relates to an image forming apparatus and in particular relates to a medium carrying device of the image forming apparatus.

### BACKGROUND

In a conventional image forming apparatus, a sheet carried from a sheet feeding tray is sent into an image forming part by a carrying roller, and printing onto the medium is performed (for example, see Japanese Patent Laid-Open Publication No. 2004-196461 (page 5, FIG. 1)).

When a medium is jammed in a carrying route, it is difficult to remove the jammed medium.

### SUMMARY

A medium carrying device includes a first carrying part and a second carrying part that are configured to carry a medium, making a nip part therebetween and a guide member that is positioned at a guide position to regulate the medium toward the nip part. The guide member includes a medium regulation part that has a surface to regulate the medium that is carried on the surface toward the nip part, an arm part that is arranged at a side of the surface and extend in a direction away from the surface, and a rotation supporting point that is formed on a distal end of the arm part that is distant from the medium regulation part, and the guide member is formed rotatable around the rotation supporting point between the guide position and a retreat position, the retreat position being more distant to the nip part than the guide position.

According to the present invention, a guide member can be moved between a guide position that is close to a nip part of a first roller and a second roller and a retreat position that is spaced apart from the contact part. Therefore, carrying performance of the medium can be improved and a jammed medium can also be easily removed.

### BRIEF DESCRIPTION OF DRAWINGS

FIG. 1 illustrates a schematic configuration diagram for describing a main part configuration of an image forming apparatus of a first embodiment that adopts a medium carrying device according to the present invention.

FIG. 2 illustrates an external perspective view of a duplex unit and a base unit that is fixed at a predetermined position inside a printer and slidably holds the duplex unit in the first embodiment.

FIG. 3 illustrates an external perspective view illustrating a state when the duplex unit is pulled out from the base unit in a direction of an arrow A in the first embodiment.

FIG. 4 illustrates an external perspective view of the base unit excluding the duplex unit in the first embodiment.

FIGS. 5A-5C illustrates configuration diagrams of the duplex unit in the first embodiment: FIG. 5A illustrates a front view; FIG. 5B illustrates a left side view; and FIG. 5C illustrates a partial cross-sectional view illustrating a portion of an A-A cross section in the left side view of FIG. 5B.

FIG. 6 illustrates a main part configuration diagram illustrating a carrying route of a recording sheet of the duplex unit in the first embodiment.

FIGS. 7A and 7B illustrate external perspective views of an inner guide viewed from different directions in the first embodiment.

FIG. 8 illustrates a partial enlarged view illustrating a main part configuration in a vicinity of the inner guide in the first embodiment when a front cover is closed.

FIG. 9 illustrates a partial enlarged view illustrating a main part configuration in the vicinity of the inner guide in the first embodiment when the front cover is opened.

FIG. 10 illustrates an explanatory diagram for describing a shape and an attachment position of the inner guide in the first embodiment.

FIG. 11 illustrates an external perspective view of a duplex unit adopted by a printer of a second embodiment based on the present invention.

FIGS. 12A-12C illustrates configuration diagrams of the duplex unit in the second embodiment: FIG. 12A illustrates a front view; FIG. 12B illustrates a left side view; and FIG. 12C illustrates a partial cross-sectional view illustrating a portion of a B-B cross section in the left side view of FIG. 12B.

FIG. 13A illustrates a partial enlarged view illustrating a main part configuration in a vicinity of an inner guide in the second embodiment when a front cover is closed; and FIG. 13B illustrates a partial enlarged view illustrating the main part configuration in the vicinity of the inner guide in the second embodiment when the front cover is opened.

### DETAILED DESCRIPTION OF EMBODIMENTS

### First Embodiment

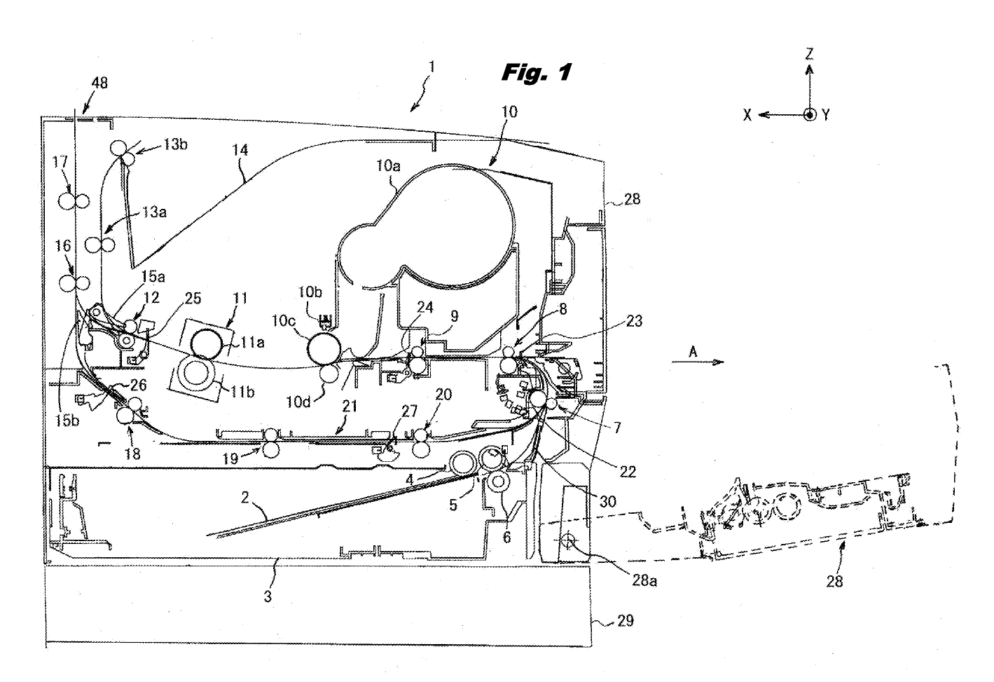

FIG. 1 illustrates a schematic configuration diagram for describing a main part configuration of an image forming apparatus of a first embodiment that adopts a medium carrying device according to the present invention.

As illustrated in FIG. 1, in a printer 1 as an image forming apparatus, a sheet feeding cassette 3 housing a recording sheet 2 as a medium that is stacked is detachably attached to a bottom part of the printer 1. The sheet feeding cassette 3 can be pulled out in a direction of an arrow A that is a front side direction of the printer 1. On an upper portion on a sheet take-out side of the sheet feeding cassette 3, a pickup roller 4 with which the recording sheet 2 that is stacked is in pressure-contact is rotatably arranged. In a vicinity of the pickup roller 4, a sheet feeding roller 5 and a retard roller 6 are arranged in a manner opposing each other for bringing out one by one the recording sheet 2 upward (to a downstream side in a sheet carrying direction), the recording sheet 2 being brought out from the sheet feeding cassette 3 by the pickup roller 4.

The recording sheet 2 that is brought out one by one by the sheet feeding roller 5 and the retard roller 6 is sent by a first registration roller pair 7, a second registration roller pair 8 and a carrying roller pair 9 that are sequentially arranged along a carrying route to an image forming part 10 that is arranged on a downstream side of these roller pairs.

The image forming part 10 is configured by a toner cartridge 10a, a recording head 10b, a photoreceptive drum 10c, a transfer roller 10d and the like, and transfers a toner image corresponding to recording data onto the recording sheet 2 that is carried. A fixing device 11 is arranged on a downstream side of the image forming part 10 in the carrying direction. The fixing device 11 is a device that fixes the toner image (that has been transferred to the recording sheet 2) onto the recording sheet 2 by heating and melting, and is configured by a fixing roller 11a and a pressing roller 11b that is in pressure-contact with the fixing roller 11a.

On a downstream side of the fixing device 11 in the carrying direction, carrying roller pairs 12 and 13a, 13b are sequentially provided along the carrying route. The recording sheet 2, onto which the toner image is fixed and which is discharged from the fixing device 11, is discharged to an ejection part 14 that is arranged on an upper part of the printer 1. In the ejection part 14, the printed recording sheet 2 is sequentially stacked. In order to detect a carrying position of the recording sheet 2 that is carried, a sensor 22 immediately before the first registration roller pair 7, a sensor 23 immediately before the second registration roller pair 8, a sensor 24 between the carrying roller pair 9 and the transfer roller 10d, and a sensor 25 between the fixing device 11 and the carrying roller pair 12 are respectively arranged.

The printer 1 is provided with a configuration capable of performing duplex printing of the recording sheet 2. Next, a case of performing duplex printing is described.

Therefore, on a downstream side of the carrying roller pair 12, a blade 15a that determines a path of the recording sheet 2, reversing roller pairs 16, 17 that switchback and carry the recording sheet 2 for carrying in and out the recording sheet 2 with respect to a retreat part 48, a blade 15b and a carrying roller 18 that guide the recording sheet 2 (that is reversed and carried) to a duplex unit 21 (to be described later) as a unit that can be pulled out, carrying roller pairs 19, 20 that carry the recording sheet 2 (that has been guided to a reversed carrying route in the duplex unit 21) again to the first registration roller pair 7, and sensors 26, 27 for performing sheet position detection are arranged.

Therefore, when performing duplex printing, the recording sheet 2, for which printing on a front side has finished, is temporarily housed in the retreat part 48 by the blade 15a and the reversing roller pair 16. Thereafter, a rear end part of the recording sheet 2 (that is housed) is sent as a front end part to the duplex unit 21 by the reversing roller pairs 16, 17 that perform the reversing, the blade 15b and the carrying roller 18. The recording sheet 2 that is sent into the duplex unit 21 is carried again to the first registration roller pair 7 by the carrying roller pairs 19, 20. A side (back side) on which printing has not been performed becomes an upper side (printing side) and printing on the back side is performed in the same way as when printing on the front side is performed.

A front cover 28 as a cover member is configured to be able to rotate about a rotation shaft 28a to be opened to an open position as illustrated in FIG. 1, in which a shape and a main part are illustrated using a dotted line, in order to pull out the duplex unit 21 in the direction of the arrow A that is the front side of the printer 1. At a lower portion of the printer 1, an optional sheet feeding cassette 29 is arranged that allows additional supply of the recording sheet 2.

X, Y and Z axes in FIG. 1 are set as follows. The X axis is along the carrying direction when the recording sheet 2 passes through the carrying rollers 8, 9. The Y axis is along a direction of a rotation axis of the photoreceptive drum 10c. The Z axis is along a direction orthogonal to the X and Y axes. Further, when the X, Y and Z axes are illustrated in other drawings (to be described later), the directions of these axes indicate common directions. That is, the X, Y and Z axes in each of the drawings indicate arrangement directions of an illustrated portion in the each of the drawings when the printer 1 illustrated in FIG. 1 is configured. Here, it is assumed that the printer 1 is arranged in such a manner that the Z axis is along a substantially vertical direction.

Next, the duplex unit 21 that is held slidable in the direction of the arrow A in the state in which the front cover 28 of the printer 1 is opened to the open position illustrated by the dotted line in FIG. 1 and a holding mechanism of the duplex unit 21 are described.

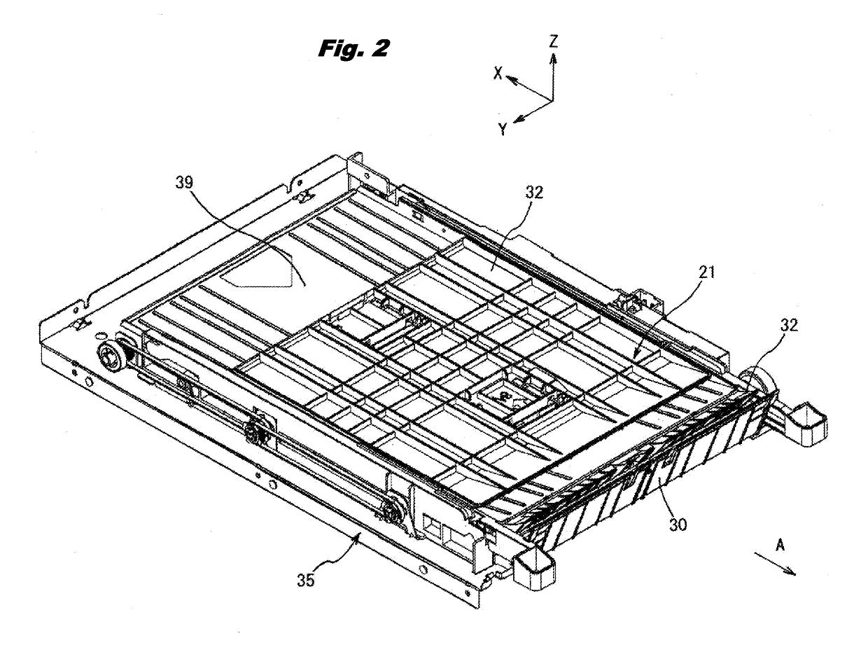

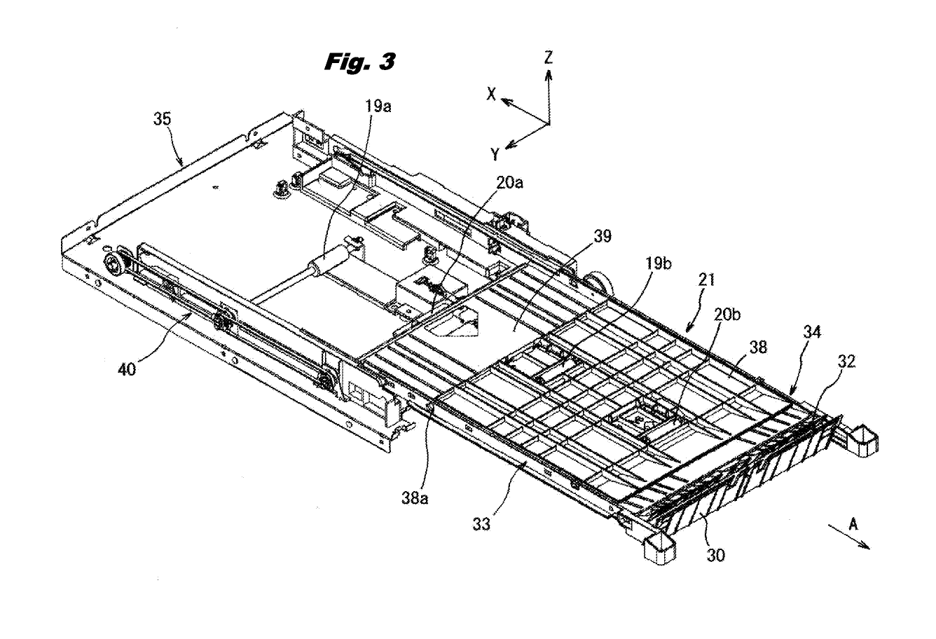

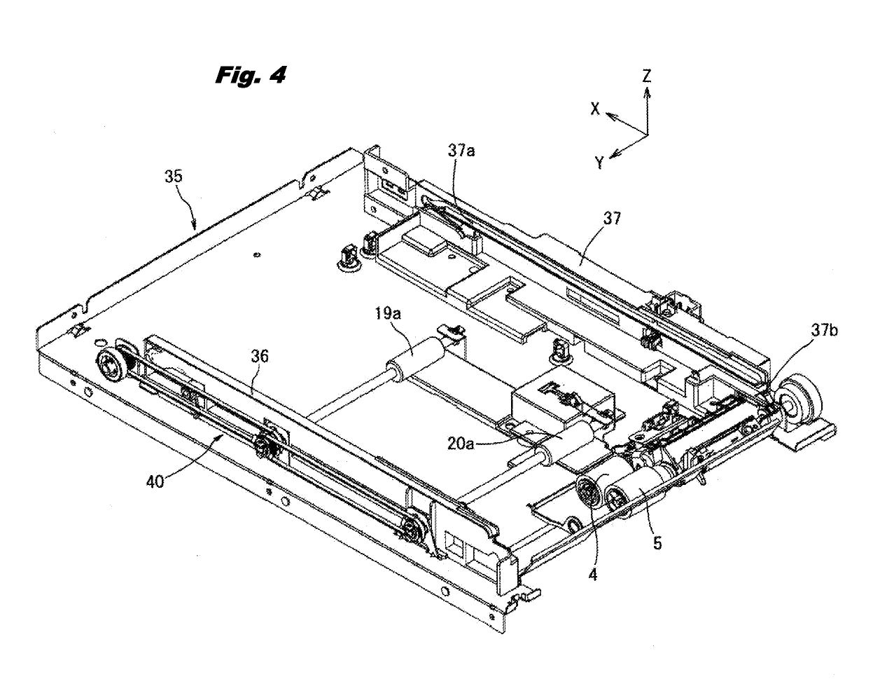

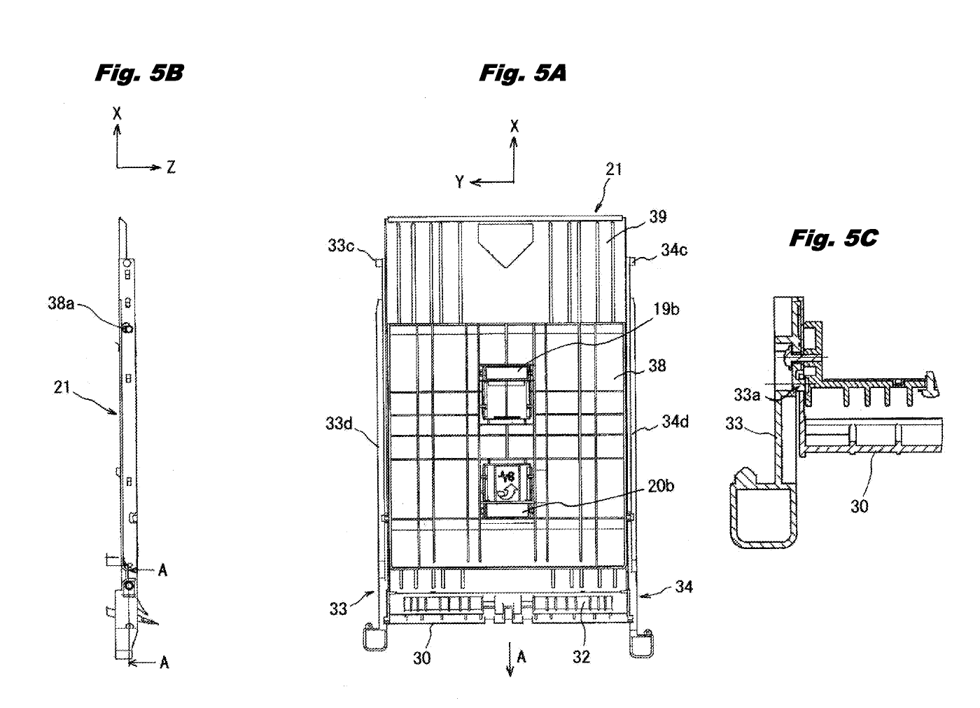

FIG. 2 illustrates an external perspective view of the duplex unit 21 and a base unit 35 that is fixed at a predetermined position inside the printer 1 and slidably holds the duplex unit 21. FIG. 3 illustrates an external perspective view illustrating a state when the duplex unit 21 is pulled out from the base unit 35 in the direction of the arrow A. FIG. 4 illustrates an external perspective view of the base unit 35 excluding the duplex unit 21. FIGS. 5A-5C illustrate configurations diagrams of the duplex unit 21. FIG. 5A illustrates a front view of the duplex unit 21; FIG. 5B illustrates a left side view of the duplex unit 21; and FIG. 5C illustrates a partial cross-sectional view illustrating a portion of an A-A cross section in the left side view of FIG. 5B.

As illustrated in FIG. 4, on the base unit 35 that is fixed on a body of the printer 1, a driving roller 19a of the carrying roller pair 19 and a driving roller 20a of the carrying roller pair 20 are rotatably held and a rotational force is transmitted via a drive transmission system 40 from the body of the printer 1. On two side of the base unit 35, an L rail 36 and R rail 37 are arranged opposing each other. On the rails 36, 37, guide grooves 36a, 37a and posts 36b, 37b that engage with predetermined parts (to be described later) of the duplex unit 21 are respectively arranged opposing each other.

However, in FIG. 4, only the guide groove 37a and the post 37b are illustrated. The guide groove 36a and the post 36b that are formed on the L rail 36 and the guide groove 37a and the post 37b that are formed on the R rail 37 are plane-symmetrically configured with respect to a virtual plane that perpendicularly intersects the base unit 35 at a central part in a width direction of the base unit 35.

As illustrated in FIG. 3, the duplex unit 21 is provided with a lower guide 39 and an upper guide 38 that are arranged opposing each other. The upper guide 38 that has a rotation supporting point 38a is rotatably attached to an L side guide 33 and R side guide 34 that are integrally formed with the lower guide 39, and is configured in a manner that a front end part of the upper guide 38 in the direction of the arrow A can rotate upward.

On the upper guide 38, a driven roller 19b of the carrying roller pair 19 and a driven roller 20b of the carrying roller pair 20 are rotatably held. As illustrated in FIG. 5, on the L side guide 33 and the R side guide 34 that are arranged on the two sides of the duplex unit 21, posts 33c, 34c that engage with the guide grooves 36a, 37a of the base unit 35 and ribs 33d, 34d that engage with the posts 36b, 37b of the base unit 35 are arranged.

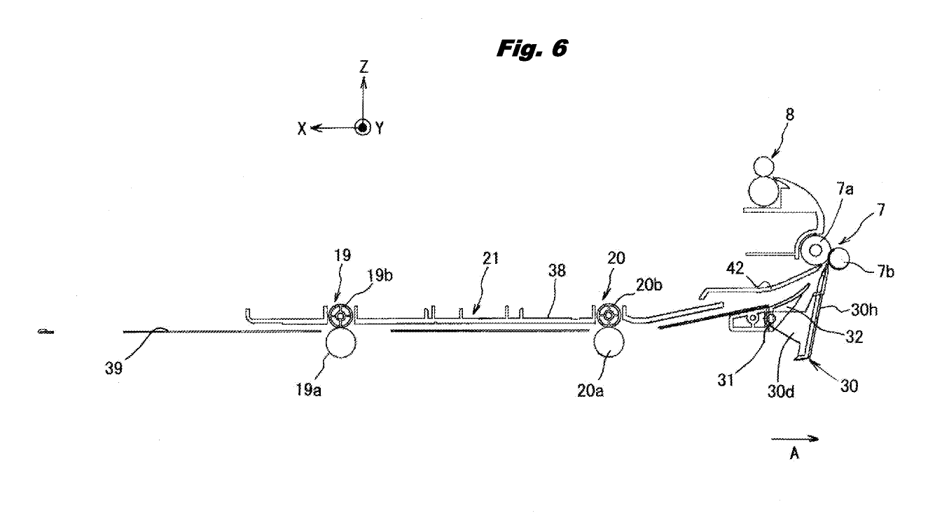

Further, on the front end part of the duplex unit 21 in the direction of the arrow A (end portion on a downstream side in a pull-out direction of the duplex unit 21), an inner guide 30 as a guide member (to be described later) having rotation supporting points 31 (FIG. 6) is supported by the two side guides 33, 34 to be rotatable about an axis parallel to the Y axis direction using the rotation supporting points 31 as a rotation shaft. The L side guide 33 and the R side guide 34 are configured to be substantially plane-symmetrical with respect to a virtual plane that perpendicularly intersects the duplex unit 21 at a central part in a width direction of the duplex unit 21. As discussed here, the guide member is rotatably arranged with respect to the duplex unit 21.

The duplex unit 21 configured as described above has, for example, as illustrated in FIG. 3, the posts 33c, 34c respectively fitted in the base unit guide grooves 36a, 37a of the base unit 35 and the ribs 33d, 34d incorporated in a state of being respectively placed on the posts 36b, 37b of the base unit 35, and is slidably movable between a pulled-out position illustrated in FIG. 3 and an attachment position illustrated in FIG. 2. The direction of the arrow A indicates in this case the direction along which the duplex unit 21 is slid from the attachment position to the pulled-out position.

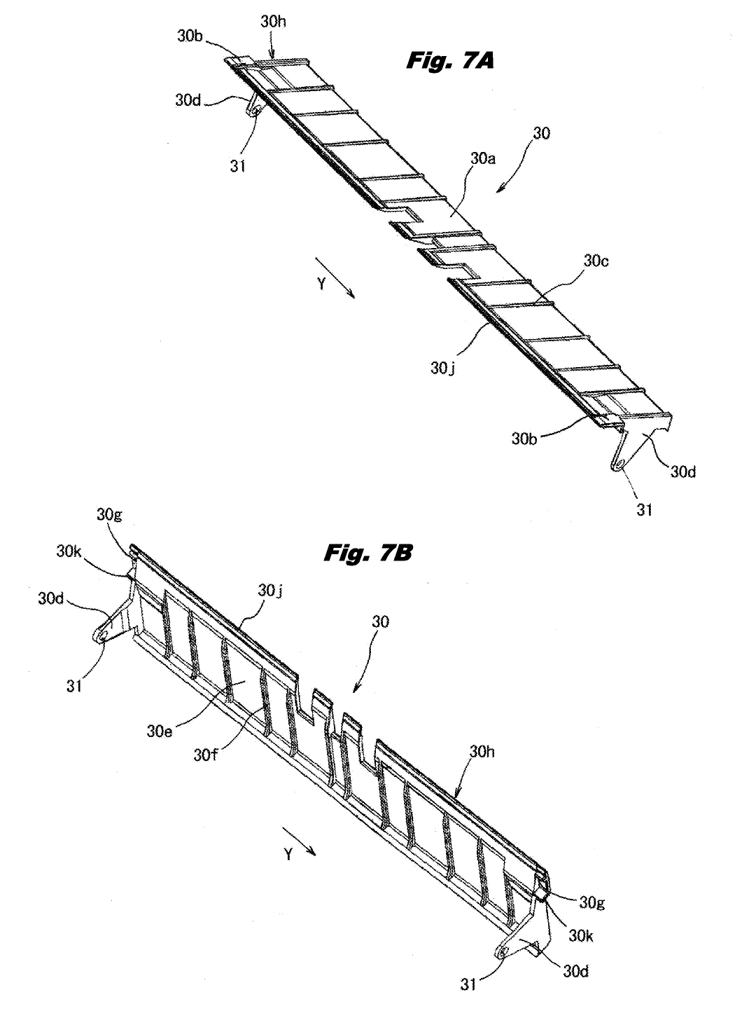

FIG. 6 illustrates a main part configuration diagram illustrating a carrying route of the recording sheet 2 of the duplex unit 21. FIGS. 7A and 7B illustrate external perspective views of the inner guide 30 viewed from different directions.

As illustrated in FIG. 6, when the duplex unit 21 is at the attachment position, the driven roller 19b and the driven roller 20b of the duplex unit 21 are respectively in contact with the driving roller 19a and the driving roller 20a of the base unit 35 to configure the carrying roller pairs 19, 20; and the recording sheet 2 is carried along a carrying route configured by the upper guide 38 and the lower guide 39 of the duplex unit 21. As will be described later, a front end part of the inner guide 30 is arranged close to a nip part of the first registration roller pair 7 by rotation associated with a closing operation of the front cover 28, and thus the inner guide 30 surely guides the recording sheet 2 (that is carried by the carrying roller pairs 19, 20 along the direction of the arrow A) to the nip part of the first registration roller pair 7.

FIG. 7A illustrates an external perspective view of the inner guide 30 viewed from a first carrying surface 30a side. FIG. 7B illustrates an external perspective view of the inner guide 30 viewed from a side of a second carrying surface 30e that is an opposite surface of the first carrying surface 30a.

As illustrated in FIGS. 7A and 7B, the inner guide 30 is as a whole in a plate shape which has longer sides in Y direction and has a medium regulation part 30h, two arm parts 30d and rotation supporting points 31. The medium regulation part 30h as a medium regulation part is a base component and has the first carrying surface 30a on one surface and the second carrying surface 30e that is formed on the opposite surface of the first carrying surface 30a. The arm parts 30d extend from both short sides of the medium regulation part 30h in a direction perpendicular to Y axis. The rotation supporting points 31 are respectively formed on tips of the arm parts 30d (or at side opposite to the medium regulation part 30h).

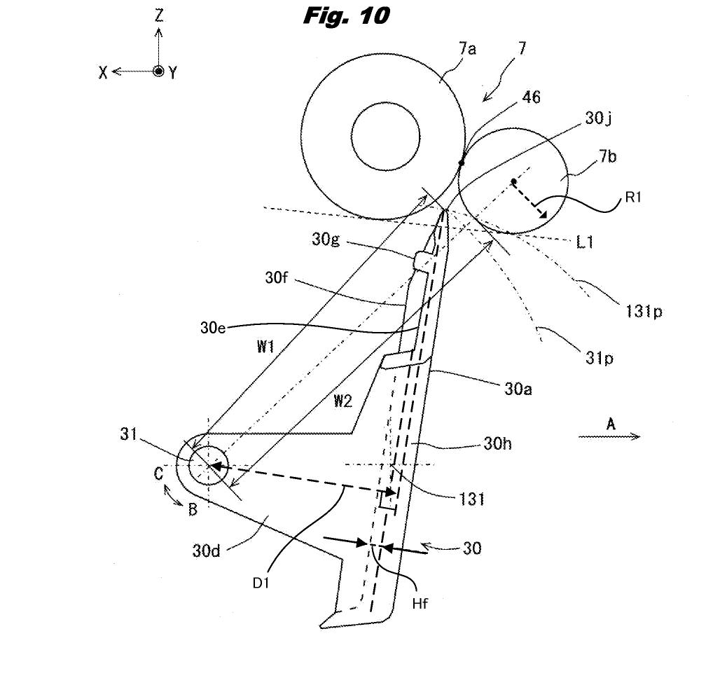

On the first carrying surface 30a of the medium regulation part 30h, ribs 30c that extend substantially parallel to the carrying direction of the recording sheet 2 are formed. Similarly, on the second carrying surface 30e, ribs 30f that extend substantially parallel to the carrying direction of the recording sheet 2 are formed. The pair of the arm parts 30d perpendicularly extend, in a manner opposing each other, from two end parts in a direction (the Y axis direction, which is a width direction of the inner guide 30) that substantially perpendicularly intersects a medium carrying direction of the medium regulation part 30h, are spaced apart with a distance larger than a maximum width of the recording sheet 2 that is carried, and are formed on the outside of a carrying area. The height of ribs 30f that is defined from the second carrying surface 30e is illustrated with Hf in FIG. 10.

Here, an example is described in which the pair of the arm parts 30d perpendicularly extends in a T-shape with respect to the medium regulation part 30h. However, the pair of the arm parts 30d may also be formed to extend in an L-shape, and as far as the pair of the arm parts 30d is formed to extend away from the medium regulation part 30h, the pair of the arm parts 30d may also be not perpendicular to the medium regulation part 30h.

In the width direction of the inner guide 30, on both end parts of the medium regulation part 30h on the first carrying surface 30a side, a pair of contact parts 30b is formed. The pair of the contact parts 30b are spaced apart with a distance larger than the maximum width of the recording sheet 2 that is carried, and are formed on the outside of the carrying area. Similarly, in the width direction of the inner guide 30, on both end parts of the medium regulation part 30h on the second carrying surface 30e side, a pair of abutting parts 30g is formed. The pair of the abutting parts 30g are spaced apart with a distance larger than the maximum width of the recording sheet 2 that is carried, and are formed on the outside of the carrying area.

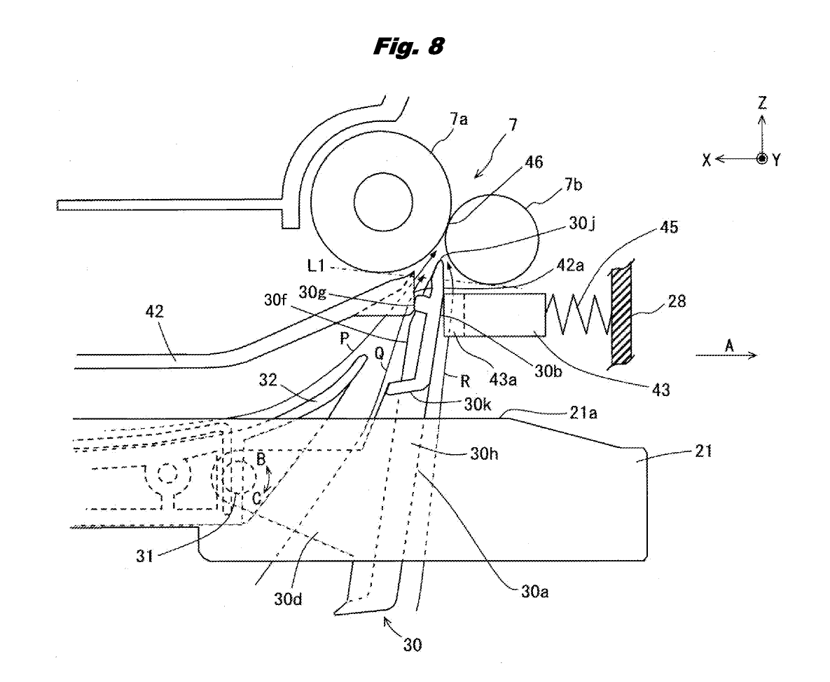

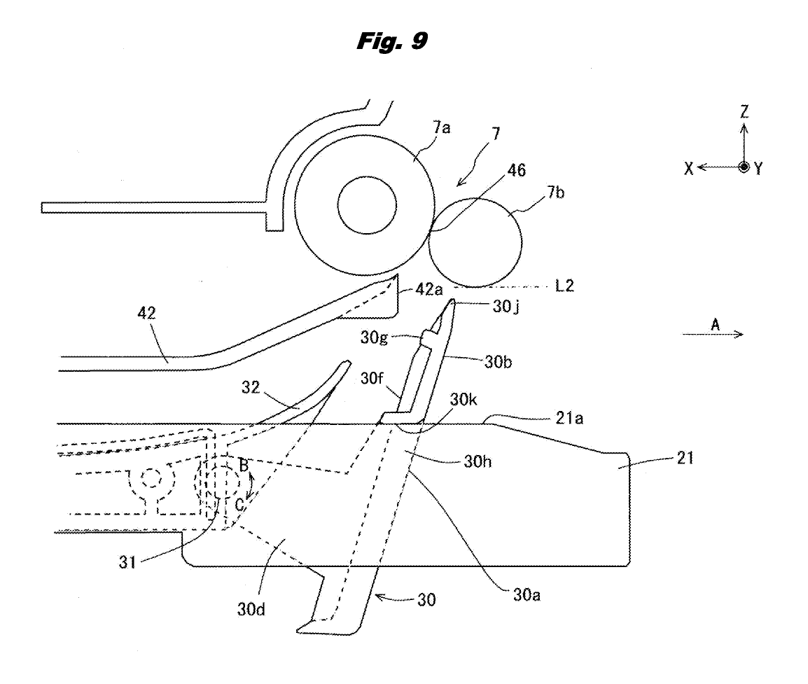

Next, a rotation operation of the inner guide 30 associated with an opening and closing operation of the front cover 28 is further described. FIG. 8 illustrates a partial enlarged view illustrating a main part configuration in a vicinity of the inner guide 30 when the front cover 28 is closed (at a close position). FIG. 9 illustrates a partial enlarged view illustrating a main part configuration in the vicinity of the inner guide 30 when the front cover 28 is opened.

First, as illustrated in FIG. 8, a state in which the front cover 28 is closed is described. In this case, the duplex unit 21 is positioned and fixed at the attachment position in the printer 1 by the base unit 35. The first registration roller pair 7 arranged in the printer 1 is configured by a driving roller 7a as a first roller that rotates by receiving a drive force and a driven roller 7b as a second roller that is driven by being in contact with the driving roller 7a.

Below the driving roller 7a, a pair of positioning contact parts 42a, which are fixed to the body of the printer 1, are formed as a second contact part on a front end part of a guide frame 42 and, following the upper guide 38 of the duplex unit 21, guides an upper side of the recording sheet 2 (that is carried through the duplex unit 21) to the first registration roller pair 7. The pair of the positioning contact parts 42a are formed at two end parts in the Y axis direction of the guide frame 42 in a manner opposing each other, are spaced apart with a distance larger than the maximum width of the recording sheet 2 that is carried, and are formed on the outside of the carrying area. The recording sheet 2, which is carried along a carrying route P shown in the figure, passes between the pair of the positioning contact parts 42a, are transferred to the first registration roller pair 7, which is located at a downstream side.

The pair of the abutting parts 30g of the inner guide 30 that is pressed by a pressing member 43 (to be described later) are respectively in contact with the pair of the positioning contact parts 42a so that rotation in a direction of an arrow B is regulated, and thus the inner guide 30 is positioned at this guide position. In this case, it is ensured that a front end part 30j of the medium regulation part 30h of the inner guide 30 that is formed in a wedge shape is arranged to be close to a nip part 46 as a contacting portion between the driving roller 7a and the driven roller 7b.

The pressing member 43 as a first contact part is provided with a pair of pressing projections 43a in a manner opposing each other at two end parts in the Y axis direction at a front-end side of the pressing member 43, and is held on the front cover 28 by a holding means (not illustrated in the drawings), for example, slidable in a direction perpendicular to the front cover 28. A coil spring 45 as a bias member is arranged between the pressing member 43 and the front cover 28. As illustrated in FIG. 8, in the state in which the front cover 28 is closed, the pair of the pressing projections 43a of the pressing member 43 that is biased by the coil spring 45 in a compressed state are respectively pressed against the pair of the contact parts 30b of the inner guide 30. Therefore, the inner guide 30 is positioned at the guide position illustrated in FIG. 8 by being sandwiched by the positioning contact parts 42a and the pressing projections 43a and is firmly maintained at this position.

Here, the front end part 30j of the inner guide 30 is arranged between the nip part 46 of the first registration roller pair 7 and an outer-circumference tangent line L1 of the driving roller 7a and the driven roller 7b. However, the front end part 30j is arranged at a position that forms predetermined gaps with respect to the driving roller 7a and the driven roller 7b in order to secure medium carrying routes P, Q, R. As a result, the carrying direction is regulated by guiding the recording sheet 2 that is carried toward the first registration roller pair 7 until immediately before the nip part 46. Thereby, medium carrying characteristics can be improved.

As described above, the positioning contact parts 42a, the abutting parts 30g, the contact parts 30b and the pressing projections 43a are arranged at positions that allow them to oppose each other. However, further, it is preferred that, as illustrated in FIG. 8, positions of opposing parts in the state in which the positioning contact parts 42a, the abutting parts 30g, the contact parts 30b and the pressing projections 43a oppose each other are arranged to be in a vicinity of the front end part 30j of the inner guide 30 and closer to the front end part 30j than the rotation supporting points 31. By adopting such an arrangement, it is possible to reduce positional variation of the front end part 30j due to factors such as vibration.

Here, carrying routes of the recording sheet 2 that is guided to the first registration roller pair 7 when the inner guide 30 is at the guide position are described. The recording sheet 2 that is carried by the carrying roller pairs 19, 20 (FIG. 6) in order to perform duplex printing is guided to the first registration roller pair 7 along the carrying route P that is guided by the guide frame 42 fixed on the body of the printer 1, a front end guide part 32 of the duplex unit 21 and the second carrying surface 30e of the inner guide 30. The recording sheet 2 that is brought out one by one from the sheet feeding cassette 3 (FIG. 1) by the sheet feeding roller 5 and the retard roller 6 is guided to the first registration roller pair 7 along the carrying route Q that is guided by the front end guide part 32 and the second carrying surface 30e. The recording sheet 2 that is fed and carried from the optional sheet feeding cassette 29 (FIG. 1) is guided to the first registration roller pair 7 along the carrying route R that is regulated by the first carrying surface 30a of the inner guide 30.

Next, as illustrated in FIG. 9, a state in which the front cover 28 is opened is described. When the front cover 28 is opened, the biasing force on the inner guide 30 due to the pressing member 43 is released so that the inner guide 30 rotates in a direction of an arrow C due to its own weight and transits from the guide position illustrated in FIG. 8 to a retreat position illustrated in FIG. 9.

In this case, when the inner guide 30 is at the guide position, the arm parts 30d of the inner guide 30 extend in a substantially horizontal direction and the medium regulation part 30h of the inner guide 30 extends in a substantially vertical direction. Therefore, a position of the gravity center of the inner guide 30 is offset to the side of the medium regulation part 30h more than the rotation supporting points 31. Therefore, when the front cover 28 is opened, the inner guide 30 rotates in the direction of the arrow C (opening direction) due to its own weight and transits to the retreat position illustrated in FIG. 9.

In this case, the rotation of the inner guide 30 in the direction of the arrow C is regulated by that abutting parts 30k formed on two end parts of the inner guide 30 in the width direction (Y axis direction) and rotation regulating parts 21a as a third contact part formed on the duplex unit 21 are in contact with each other, so that the inner guide 30 is positioned at the retreat position illustrated in FIG. 9 and remains at this position. Further, when the inner guide 30 is at the retreat position, the front end part 30j of the inner guide 30 is positioned vertically below an outer-circumference tangent line L2 of the driven roller 7b, the outer-circumference tangent line L2 being parallel to the direction of the arrow A, which is the pull-out direction of the duplex unit 21. As a result, when the duplex unit 21 is pulled out in the direction of the arrow A, the inner guide 30 and the driven roller 7b do not come into contact with each other. As discussed here, the duplex unit 21 is detachable or slidable with respect to the body of apparatus. In FIG. 1, the body of apparatus is very simply illustrated with the outer grid line of reference 1. The outer grid line indicates the structure of the body.

Therefore, when the recording sheet 2 that is carried is jammed in the duplex unit 21, as illustrated in FIG. 3, by pulling out the duplex unit 21 from the base unit 35 in the direction of the arrow A and rotating the upper guide 38 upward at outside of the printer 1 to open the inside of the duplex unit 21, the recording sheet 2 jammed in the duplex unit 21 can be removed.

FIG. 10 illustrates an explanatory diagram for describing a shape and an attachment position of the inner guide 30. With reference to FIG. 10, the shape and the attachment position of the inner guide 30 are further described.

FIG. 10 illustrates a state in which the inner guide 30 is supported by the body of the duplex unit 21, which is positioned at the attachment position in the printer 1, to be rotatable about an axis parallel to the Y axis using the rotation supporting points 31 as a rotation shaft, and is further maintained by the above-described pressing member 43 at the guide position in which the abutting parts 30g of the inner guide 30 are in contact with the positioning contact parts 42a (see FIG. 8).

In this case, the front end part 30j of the inner guide 30 is arranged between the nip part 46 of the first registration roller pair 7 and the outer-circumference tangent line L1 of the driving roller 7a and the driven roller 7b, which is positioned at the lower part of the pair 7. It is necessary to attach the rotation supporting points 31 that are used as a center of rotation in such a manner that the front end part 30j of the inner guide 30 does not come into contact with the driven roller 7b, which is positioned on a downstream side, when the inner guide 30 rotates in the direction of the arrow C from the guide position to the retreat position illustrated in FIG. 9. For example, when the rotation supporting points 31 are attached at the position illustrated in FIG. 10, the front end part 30j draws a rotation path 31p and thus does not come into contact with the driven roller 7b. When the inner guide 30 rotates from the guide position in the direction of the arrow C, in an initial stage of the rotation, particularly the vicinity of the front end part 30j of the medium regulation part 30h moves in substantially the direction of the arrow A. Therefore, for convenience, this may be sometimes expressed as rotating in the direction of the arrow A.

As described above, in order to avoid contact between the front end part 30j and the driven roller 7b, when a distance from the rotation supporting point 31 to the front end of the front end part 30j is W1 and a shortest distance from the rotation supporting point 31 to the driven roller 7b that is positioned on a downstream side more than the front end part 30j in the rotation direction (on the side of the direction of the arrow A) is W2, the rotation supporting point 31 of the inner guide 30 is positioned at a position such that

W1<W2

is satisfied.

In contrast, as a comparative example, when the center of rotation of the inner guide 30 is moved, for example, to a virtual center 131 that overlaps with the medium regulation part 30h, since W1>W2 and the front end part 30j draws a rotation path 131p. Therefore, the front end part 30j comes into contact with the driven roller 7b so that the inner guide 30 cannot rotate to the retreat position.

Therefore, in the inner guide 30 of the present embodiment that has the flat plate-shaped medium regulation part 30h that includes the front end part 30j, the first carrying surface 30a and the second carrying surface 30e formed on the opposite side of the first carrying surface 30a, the arm parts 30d are arranged on the two end parts of the medium regulation part 30h in the width direction extending in a direction away from the medium regulation part 30h, and the rotation supporting points 31 are formed on front end parts of the arm parts 30d. The arm parts 30d are arranged to extend on the side of the medium regulation part 30h at the guide position that is opposite to the driven roller 7b (on the side of the driving roller 7a), that is, the opposite side of the side of the direction of the arrow A, and are attached to the body of the duplex unit 21. The driven roller 7b in this case is positioned on the downstream side in the rotation direction (the direction of the arrow A) when the inner guide 30 rotates from the guide position to the retreat position in the direction of the arrow C.

Further, in the inner guide 30 that is formed as described above, its gravity center is offset to the side of the medium regulation part 30h more than the rotation supporting points 31. Therefore, due to its own weight, the inner guide 30 can rotate in the direction of the arrow C to the above-described retreat position.

As described above, according to the printer of the present embodiment, it is possible to allow the inner guide 30 that is rotatably supported on the body of the duplex unit 21 to approach, at the guide position, the vicinity of the nip part 46 of the first registration roller pair 7 in order to surely guide the recording sheet 2, and to rotate to the retreat position to allow the duplex unit 21 to be pulled out without interfering with the driven roller 7b of the first registration roller pair 7.

Further, at the retreat position, the first registration roller pair 7 and the inner guide 30 are spaced apart from each other. Therefore, a medium jammed in the vicinity of the first registration roller pair 7 can be easily removed. Further, the inner guide 30 is provided on an end part on a pull-out side of the duplex unit 21 (the direction of the arrow A). Therefore, by pulling out the duplex unit 21 for only a small amount, a medium jammed in a vicinity of the inner guide 30 can be even more easily removed and the pulling out of the duplex unit 21 can be easily performed.

### Second Embodiment

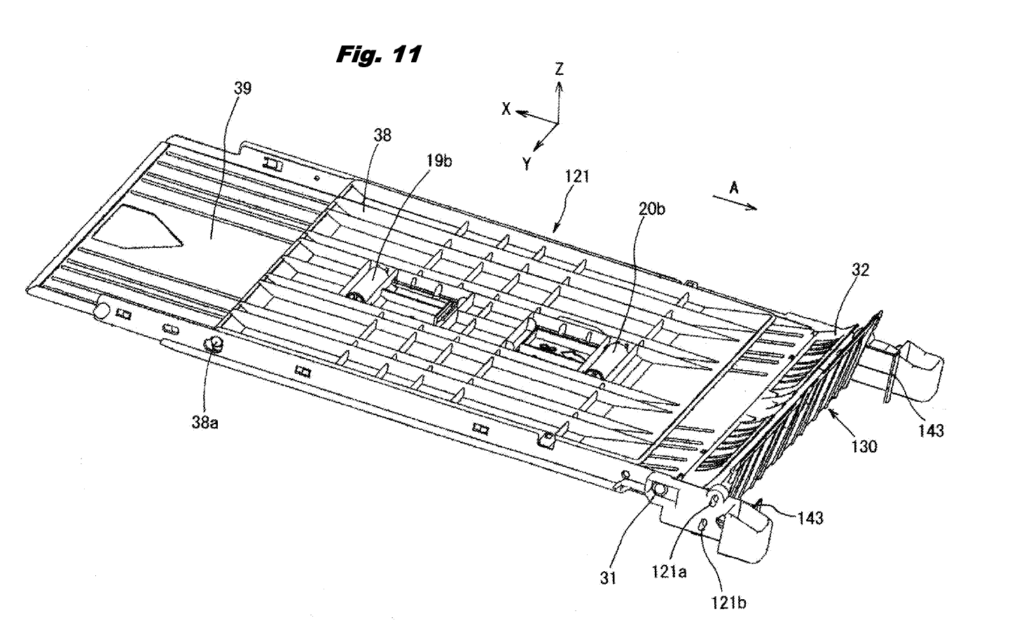

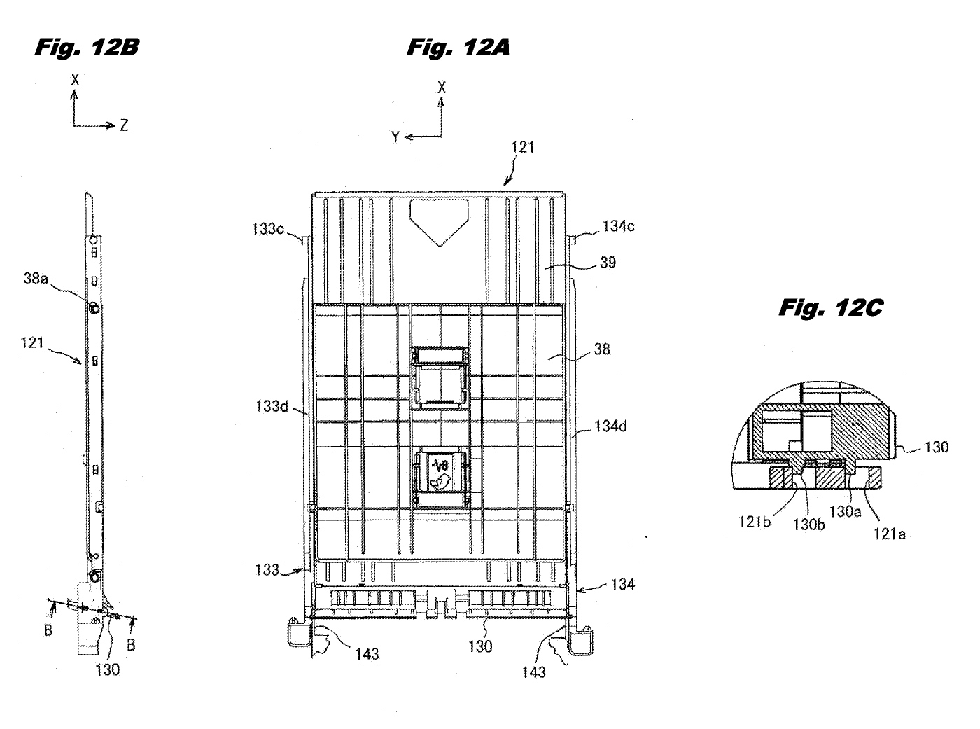

FIG. 11 illustrates an external perspective view of a duplex unit 121 adopted by a printer of a second embodiment based on the present invention. FIGS. 12A-12C illustrate configurations diagrams of the duplex unit 121. FIG. 12A illustrates a front view of the duplex unit 121; FIG. 12B illustrates a left side view of the duplex unit 121; and FIG. 12C illustrates a partial cross-sectional view illustrating a portion of a B-B cross section in the left side view of FIG. 12B.

Main differences between the printer adopting the duplex unit 121 and the above-described printer 1 illustrated in FIG. 1 are a shape, an attachment method and operation details of an inner guide 130 as a guide member in the duplex unit 121. Therefore, for the printer adopting the duplex unit 121, parts that are in common with the above-described printer 1 (FIG. 1) of the first embodiment are denoted using the same reference numeral symbols, or are omitted from the drawings and their description is omitted, and the differences are mainly described. Further, a main part configuration of the printer of the present embodiment, excluding the duplex unit 121, is in common with the main part configuration of the printer 1 of the first embodiment illustrated in FIG. 1. Therefore, refer to FIG. 1 as needed.

On a front end part in the direction of the arrow A of the duplex unit 121 of the present embodiment, the inner guide 130 (to be described later) having posts 130a, 130b on both end parts in a direction (width direction of the inner guide 130) that substantially perpendicularly intersects the medium carrying direction is supported to be slidable in a substantially up-down direction by guide long holes 121a, 121b that are respectively formed on two side guides 133, 134. The side guide L133 and the side guide R134, and the inner guide 130, are configured to be substantially plane-symmetrical with respect to a virtual plane that perpendicularly intersects the duplex unit 121 at a central part in the width direction of the duplex unit 121.

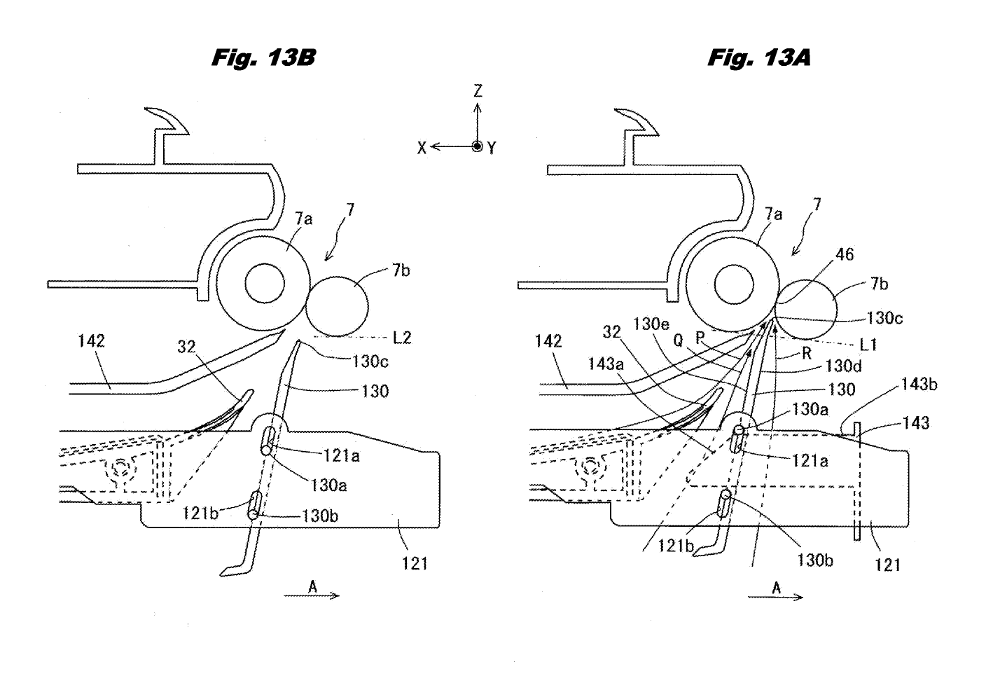

Next, an up-down movement operation of the inner guide 130 associated with an opening and closing operation of the front cover 28 (FIG. 1) is described. FIG. 13A illustrates a partial enlarged view illustrating a main part configuration in a vicinity of the inner guide 130 when the front cover 28 is closed. FIG. 13B illustrates a partial enlarged view illustrating the main part configuration in the vicinity of the inner guide 130 when the front cover 28 is opened.

First, as illustrated in FIG. 13B, a state in which the front cover 28 is opened is described. In this case, due to its own weight, the inner guide 130 is in a lowermost position of an up-down movable range that corresponds to a retreat position. When the inner guide 130 is in the retreat position, it is ensured that a front end part 130c of the inner guide 130 is positioned vertically below the outer-circumference tangent line L2 of the driven roller 7b, the outer-circumference tangent line L2 being parallel to the direction of the arrow A, which is the pull-out direction of the duplex unit 121. As a result, when the duplex unit 121 is pulled out in the direction of the arrow A, the inner guide 130 and the driven roller 7b do not come into contact with each other.

When the front cover 28 is closed from this state, during this process, an engagement projection 143 (see FIG. 13A) arranged on the front cover 28 approaches the post 130a of the inner guide 130 from an opposite direction of the arrow A, and first an inclined part 143a of the engagement projection 143 comes into contact with the post 130a to push the post 130a upward along the guide long hole 121a. Therefore, along with this, the entire inner guide 130 rises.

When the front cover 28 is eventually closed, as illustrated in FIG. 13A, the post 130a rises over the inclined part 143a to reach a horizontally formed upper side 143b of the engagement projection 143 and is in a state of being placed on the upper side 143b. A sliding position of the inner guide 130 in this case corresponds to the guide position.

When the inner guide 130 is at this guide position, the front end part 130c of the inner guide 130 is arranged between the nip part 46 of the first registration roller pair 7 and the outer-circumference tangent line L1 of the driving roller 7a and the driven roller 7b. However, the front end part 130c is arranged at a position with respect to the driving roller 7a and the driven roller 7b that forms predetermined gaps in order to secure the medium carrying routes P, Q, R. As a result, the carrying direction is regulated by guiding the recording sheet 2 that is carried toward the first registration roller pair 7 until immediately before the nip part 46. Thereby, medium carrying characteristics can be improved.

Here, carrying routes of the recording sheet that is guided to the first registration roller pair 7 when the inner guide 130 is at the guide position are described. The recording sheet 2 that is carried by the carrying roller pairs 19, 20 (FIG. 6) in order to perform duplex printing is guided to the first registration roller pair 7 along the carrying route P that is guided by a guide frame 142 fixed on the body of the printer 1, the front end guide part 32 of the duplex unit 121 and a second carrying surface 130e of the inner guide 130. The recording sheet 2 that is brought out one by one from the sheet feeding cassette 3 (FIG. 1) by the sheet feeding roller 5 and the retard roller 6 is guided to the first registration roller pair 7 along the carrying route Q that is guided by the front end guide part 32 and the second carrying surface 130e. The recording sheet 2 that is fed and carried from the optional sheet feeding cassette 29 (FIG. 1) is guided to the first registration roller pair 7 along the carrying route R that is regulated by a first carrying surface 130d of the inner guide 130.

As described above, according to the printer of the present embodiment, it is possible to allow the inner guide 130 that is slidably supported on a body of the duplex unit 121 to approach, at the guide position, the vicinity of the nip part 46 of the first registration roller pair 7 in order to surely guide the recording sheet 2, and to slide to the retreat position to allow the duplex unit 121 to be pulled out without interfering with the driven roller 7b of the first registration roller pair 7. Further, at the retreat position, the first registration roller pair 7 and the inner guide 130 are spaced apart from each other. Therefore, a medium jammed in the vicinity of the first registration roller pair 7 can be easily removed.

(1) Two Positions of Guide Member

In the above embodiments, the guide member (30, 130) is movable and takes two different positions. One is the guide position and the other is the retreat position. The two positions are realized in correspondence with open/close position of the cover (28). See FIGS. 8, 10 and 13A for the guide position, FIGS. 9 and 13B for the retreat position.

(1.1) Guide Position

At the guide position, the guide member is arranged close to two carrying parts (7a and 7b) so that the medium is delivered to the nip part of the carrying parts.

When the guide member is attached to the unit (21, 121), it is preferred that the front end part (30j, 130c) of the guide member is located above the outer-circumference tangent line (L2) of the carrying part at the bottom. The carrying part is one that is positioned at the downstream side of the pull-out direction of the unit, see FIG. 9, because the closer the inner guide is, the more securely the medium can be delivered to the nip part. Further, it is more preferred that the inner guide is positioned above the connecting line (L1) that is an imaginary line connecting the outer circumferences of the two carrying parts at the bottoms. According to the above preferred embodiments, the guide member is disclosed to be positioned at the guide position at states where the cover is fully closed and where the unit is fully inserted.

(1.2) Retreat Position

At the retreat position, the guide member is arranged away from the carrying parts. The front end part also is away from the nip part so that the medium is not delivered to the nip part.

When the guide member is attached to the unit, it is preferred that the front end part of the guide member is positioned below the outer-circumference tangent line (L2). That is because, when the unit is pulled out, moving rightward in FIG. 9, the front end part does not contacts the carrying part. The unit can be easily taken out of the apparatus. According to the above preferred embodiments, the guide member is disclosed to be positioned at the retreat position at states where the cover is open (or not fully closed) and where the unit is not fully inserted.

(2) Moving in Correspondence with Open/Close of Cover

The bias member (or coil spring 45 for example) is positioned in the vicinity of the guide member, the bias member reacting in correspondence with open/close status of the cover so that the position of the guide member is switched according to with/without the biasing force generated with the bias member. When the cover is closed, the bias force directing to the same direction as the cover is closing is applied to the guide member so that the guide member remains at the guide position.

On the other hand, when the cover is opened, the bias force is not generated so that the guide member not having the bias force moves from the guide position to the retreat position due to its own weight. In order to realize the feature, the gravity center is, in a view of the width of the medium regulation part, not located vertically above the rotation supporting points. In a claim below, it is recited that the gravity center is not located above the distal ends of the arm parts. The “distal ends” does not necessary means the most distant portion of the arm parts. As long as a certain distance from the medium regulation part is obtained, any portion of the arm part can be interpreted as the distal ends.

Further, specific structures of distances D1 and W1 are disclosed below. The distance D1 is defined a length perpendicular from the rotation supporting point toward the medium regulation part. Putting it another way, the D1 is the shortest length from the rotation supporting point to the medium regulation part. The distance W1 is defined as a length from the rotation supporting point.

In view of securing a large distance from the carrying parts by moving to the retreat position, it is preferred to make the distance W1 as large as possible. Also, making the distance D1 large brings an advantage that a torque due to the own weight becomes large. On the other hand, making the distances W1 and D1 very large does not suit a design thought to make the apparatus compact.

(2.1) Distance W1

Considering those matters, it is preferred that the distance W1 ranges within 30 mm to 50 mm, more preferably around 40 mm. In a view of a proportion to radius R1 of the carrying part, it is preferred that the proportion of W1 to R1 (W1/R1) ranges within 600% to 1,000%, more preferably around 800%. Based on the proportion, it is assumed that a preferred R1 is around 5 mm.

(2.2) Distance D1

Similar to the distance W1, it is preferred that the distance D1 ranges within 10 mm to 30 mm, more preferably around 20 mm. In a view of a proportion to radius R1 of the carrying part, it is preferred that the proportion of D1 to R1 (D1/R1) ranges within 200% to 600%, more preferably around 400%. Based on the proportion, it is assumed that a preferred R1 is around 5 mm.

(3) Carrying Part(s)

In the embodiments on the application, the carry of the medium (sheet) is realized with a pair of rollers (7a, 7b). However, other structures can be applied. For example, it is practical to use a combination of a drive roller and a panel, and a combination of a pair of panels that rub each other in order to carry the medium therebetween. Further, according to the embodiments above, the nip part 46 indicates a contact portion created by two rollers. However, the nip part is not necessarily limited to the contact portion. A contact portion by a roller and a panel and a contact portion by two panels as well are categorized in the nip part.

(4) Retreated Member

A retreated member of the invention, recited in Claim 14, is a part of configuration that is designed to carry the medium. The carrying part(s) discussed above is one example. More specifically, the pair of rollers 7a and 7b is categorized. As discussed above, not only a roller but a panel and panels also can be categorized in the retreated member.

(5) Three Carrying Routes P, Q, R

In the invention, three carrying routes P, Q, R for carrying the medium to the carrying parts (7a, 7b) that is positioned at the upstream side of these routes are designed, see FIGS. 8 and 13A. Route P is created with the guide frame (42 or 142) and the front end part 32. Route Q is created with the front end part 32 and the inner guide 30 or 130. Route R is created with the inner guide and the pressing member 43.

(5.1) Positioning Contact Part 42a

As illustrated in FIG. 8, the guide frame 42 has the positioning contact part 42a at one end that is at the downstream side so that the positioning contact part 42a is in contact with the abutting part 30a of the inner guide 30. As there is a pair of abutting parts 30g at the both sides of the guide frame 42 in the width direction (or Y direction in the figures) shown in FIG. 7B, the guide frame 42 has another positioning contact part 42a at the other side, which is not illustrated in FIG. 8 so that two of the positioning contact parts 42a respectively meet two of the abutting parts 30g. With the meeting, a grid space is created with the positioning contact parts 42a, guide frame 42, abutting parts 30g and inner guide 30. The distance between the positioning contact parts 42a in the width direction is set larger than a width of the medium. The distance between the abutting parts 30g in the width direction is also set larger than the width of the medium. Therewith, the positioning contact parts 42a and the abutting parts 30g are located outside the routes P and Q along which the medium passes. The dotted lines of routes P and Q at the positioning contact part 42a in FIG. 8 mean that the routes are sandwiched between the positioning contact parts 42a in the width view (Y direction view).

(5.2) Front End Guide Part 32

In the above embodiment, the front end guide part 32 does not has any portions that contact either the guide frame 32 or the inner guide 30. The front end guide part 32 has a shorter width than the distances of the positioning contact parts 42a and the abutting parts 30g. Thereby, the front end guide part 32 does not contribute to create the grid space. However, it is practical for the front end guide part 32 to have one or pair of projection portions at the side and to contribute to create another grid space for passing the medium or to guide the medium toward the downstream.

(5.3) Pressing Projections 43a

As illustrated in FIG. 8, the pressing member 43 has the pressing projection 43a at one end that is close to the inner guide 30 and at one side in the width direction so that the pressing projection 43a is in contact with the surface 30a of the inner guide 30. Even not illustrated, the pressing member 43 has another pressing projection 43a at the other side. Each of the pressing projections 43a contacts the surface 30a so that a grid space is created with the pressing projections 43a and pressing member 43 and the surface 30a of the inner guide 30. The distance between the pressing projections 43a in the width direction is larger than the width of the sheet. Therewith, the pressing projections 43a are located outside the route R along which the medium passes. The dotted line of route R at the pressing projection 43a in FIG. 8 means that the route is sandwiched between the pressing projections 43a in the width view.

In the embodiment illustrated in FIGS. 7A and 7B, the two arm parts 30d are arranged at the both sides of the inner guide 30, making it possible to carry the medium between the arm parts 30d. It is, however, not necessary to use two arm parts. As long as the rotation supporting point 31 (or rotation center) of the inner guide 30 is offset from the medium regulation part 30h, putting it another way, maintaining the distance D1 in FIG. 10, a single arm part or three ore more arm parts are available. For example, a single arm part can be disposed entirely in the lateral direction (Y direction) of the inner guide 30 so that a surface of the arm part as well forms a part of the medium carrying route. Such an arm part is preferred when the width of the inner guide 30 ranges within 10 to 20 mm, or when it is adopted for a small printer, for example, a printer designed to print price tags. A single arm part can be disposed in the middle of the width or multiple arm parts can be aligned in the width direction with certain intervals.

There are stable members and movable members in the application. It is clear by comparing FIGS. 8 and 9, and also FIGS. 13A and 13B that the inner guides 30 and 130 (or guide member) are movable with respect to the body of apparatus. The guide frames 42 and 142 and the front end guide part 32 are stable or not movable with respect to the body of apparatus.

### INDUSTRIAL APPLICABILITY

In the above-described embodiments, the present invention is described using a black-and-white electrophotographic printer capable of performing duplex printing as an example. However, the present invention is not limited to this, but is also applicable to an image forming apparatus, such as a copying machine, a facsimile, or an MFP, that is capable of performing simplex printing or duplex printing. Further, a black-and-white printer is described, but the printer may also be a color printer.

What is claimed is:

1. A medium carrying device comprising:
a first carrying part and a second carrying part that are configured to carry a medium, contact each other and make a nip part therebetween; and
a guide member that is positioned at a guide position to regulate the medium toward the nip part, wherein
the guide member comprises
a medium regulation part that has a surface to regulate the medium that is carried on the surface toward the nip part;
an arm part that is arranged at a side of the surface and extend in a direction away from the surface; and
a rotation supporting point that is formed on a distal end of the arm part that is distant from the medium regulation part, and
the guide member is formed rotatable around the rotation supporting point between the guide position and a retreat position, the retreat position being more distant to the nip part than the guide position.

2. The medium carrying device according to claim 1, wherein
the first carrying part is a drive roller that is driven by a given force, and
the second carrying part is a driven roller that is driven in correspondence with a rotation of the first carrying part.

3. The medium carrying device according to claim 1, wherein
the first carrying part is a first carrying roller, and
the second carrying part is a second carrying roller.

4. The medium carrying device according to claim 3, wherein,
when the guide member is at the guide position, a front end part of the medium regulation part is positioned, in a width view of the medium regulation part, between the nip part and a lower outer-circumference tangent line (L1) of the first roller and the second roller.

5. The medium carrying device according to claim 1, wherein,
when the guide member is at the guide position, the medium regulation part is sandwiched by a first contact part that is formed on a cover member that is pivotal to open and to close and a second contact part that is fixedly arranged with respect to a body of the medium carrying device.

6. The medium carrying device according to claim 5, comprising
a bias member that is arranged between the first contact part and the cover member and biases the first contact part toward the medium regulation part.

7. The medium carrying device according to claim 5, wherein
the first contact part and the second contact part sandwich the medium regulation part in a vicinity of the front end part of the medium regulation part.

8. The medium carrying device according to claim 1, wherein
the guide member is arranged in a unit that is configured to be pulled out with respect to a body of an image forming apparatus, and
the guide member moves toward a pull-out direction of the unit during a rotation around the rotation supporting point starting at the guide position.

9. The medium carrying device according to claim 8, wherein
rotation of the guide member from the guide position toward the retreat position is stopped with a third contact part that is formed on the unit, and,
at the retreat position, the guide member is vertically below an outer-circumference tangent line (L2) of the second roller at the bottom, the outer-circumference tangent line being parallel to the pull-out direction of the unit.

10. The medium carrying device according to claim 8, wherein
the guide member is arranged on a downstream side in the pull-out direction of the unit.

11. A medium carrying device comprising:
a first roller and a second roller that are configured to carry a medium, contact each other and make a nip part therebetween;
an unit that is slidably attached to a body of an image forming apparatus so that the unit is pulled out in a pull out direction,
a guide member that is movably attached to the unit so that the guide member takes a guide position at which the guide member regulates the medium toward the nip part and a retreat position at which the guide member does not carry the medium toward the nip part, wherein
when the guide member is at the retreat position, a front end part of the guide member is positioned vertically below an outer-circumference tangent line (L2) of the second roller, the outer-circumference tangent line being parallel to the pull-out directing of the unit.

12. The medium carrying device according to claim 1, wherein
the arm part is a pair of arm parts that are respectively formed at both sides of the surface of the medium regulation part,
the rotation supporting point is a pair of rotation supporting points that are respectively formed on the distal ends of the arm parts.

13. An image forming apparatus comprising:
the medium carrying device according to claim 1.

14. A medium carrying device comprising:
a guide member that is positioned at a guide position to regulate a medium toward a downstream side of a medium carrying route; and
a retreated member that is positioned at the downstream side from the guide member, and that is in a vicinity of the guide member and when the guide member is at the guide position, wherein
the guide member comprises
a medium regulation part that has a surface to regulate the medium that is carried on the surface toward the retreated member;
an arm part that is arranged at a side of the surface and extends in a direction away from the surface; and
a rotation supporting point that is formed on a distal end of the arm part that is distant from the medium regulation part,
the guide member is formed rotatable around the rotation supporting point between the guide position and a retreat position, and
the arm part extends in a direction opposite to a direction in which the guide member rotates toward the retreat position.

15. The medium carrying device according to claim 14, wherein
the retreated member comprises
a first carrying part and a second carrying part that are configured to carry a medium, contact each other, making a nip part therebetween,
the guide member at the guide position guides the medium toward the nip part,
the guide member is formed to be rotatable in a direction from the guide position toward the second carrying part, and
the rotation supporting point is arranged on a first carrying part side of the medium regulation part that is at the guide position.

16. An image forming apparatus for forming an image on a medium using developer, comprising:
a body;
a medium carrying device that is arranged inside the body and carries the medium to a downstream of a medium carrying route;
a cover member that is in a plate shape, is attached to an outer frame of the body at one end thereof so that the cover member is pivotal around the one end between an open position and a close position, the cover member covering the medium carrying device at the close position and not covering the medium carrying device at the open position, wherein
the medium carrying device comprises
a pair of rollers that is positioned at the downstream from the medium carrying device, that are in contact at a nip part, and further carries the medium from the medium carrying device through the nip part toward the downstream along the medium carrying route,
a guide member that includes
a medium regulation part that is in a plate shape having an front end and two sides with a longer width than that of the medium so that the medium runs through a middle of the two sides, and
two arm parts that are respectively arranged at the two sides, having supporting points at a distal end thereof that is distant from the medium regulation part, functioning to movably connecting the guide member with respect to the body so that the guide member moves between a guide position and a retreat position, at the guide position the front end of the medium regulation part being close to the nip part so that the medium is conveyed to the nip part, and at the retreat position the front end not being close to the nip part so that the medium is not conveyed to the nip part,
a bias member that is arranged between the guide member and the cover member, that applies a biasing force to the guide member in a direction from the cover member to the guide member when the cover member is at the close position so that the guide member remains at the guide position, and that does not apply the biasing force to the guide member when the cover member is at the open position so that the guide member moves to the retreat position due to an own weight thereof.

17. The image forming apparatus according to claim 16, further comprising:
a unit that contains a plurality of media, and supplies the media one by one, wherein
the unit is installed in the body at an upstream of the medium carrying route from the guide member,
the guide member is rotatably attached at distal ends of the arm parts so that the guide member pivots between the guide position and the retreat position around the distal ends,
a gravity center of the guide member is, in a view of the width of the medium regulation part, not located above the distal ends of the arm parts but at a side of the cover member,
when the cover member is at the close position, the guide member remains at the guide position, and
when the cover member is at the open position, the guide member remains at the retreat position.

18. The image forming apparatus according to claim 16, further comprising:
a unit that contains a plurality of media, and supplies the media one by one, wherein
the unit is installed in the body at an upstream of the medium carrying route from the guide member,
the guide member is slidably attached at distal ends of the arm parts so that the guide member moves upward to the guide position and downward to the retreat position along a sliding direction,
one surface of the bias member facing the guide member is inclined with respect to the sliding direction, of which a leading end of the inclined surface is at a bottom side of the bias member,
when the cover member is at the close position, the guide member is pushed upward due to the inclined surface so that the guide member remains at the guide position, and
when the cover member is at the open position, the guide member is not pushed upward due to no contact with the inclined surface so that the guide member remains at the retreat position.
